(19) United States
(12) Patent Application Publication
(10) Pub. No.: US 2009/0071462 A1
(43) Pub. Date: Mar. 19, 2009

(54) Barbecue Grill Transmission Device

(76) Inventor: George Liu, Douliou City (TW)

Correspondence Address: APEX JURIS, PLLC, 12733 LAKE CITY WAY NORTHEAST, SEATTLE, WA, 98125, US

(21) Appl. No.: 11/856,026

(22) Filed: Sep. 15, 2007

(51) Int. Cl. A47J 37/07

(52) U.S. Cl. 126/25 R

(57) ABSTRACT

The present invention is to provide a barbecue grill transmission device includes a grill platen having a grill shelf mounted at the top thereof, and a pair of grooves at two sides of the grill shelf for pivotally a rolling shaft, which is used to string up food to be roasted, wherein one end of the rolling shaft is connected to a spiral spring, whose releasing speed is reduced by a reduction gear. Further, the spring is connected to a detector, which receives a signal related to the releasing of the spring and then transmits a signal to a beeper for generating a sound to warn the completely releasing of the spring, thereby automatically rolling the food strung on the rolling shaft to roll on the grill shelf, so as to achieve power saving.

### FIELD OF THE INVENTION

The present invention is related to a barbecue grill, and more particularly to a barbecue grill whose rolling shaft on the grill platen can be rolled by a flexible recovering force, so as to save the power.

### BACKGROUND OF THE INVENTION

In the market, the common large-sized barbecue grills, as shown in FIG. 1, mostly have wheels for moving outside the house, or for being carried to the outdoors as go vacationing. However, since it is more and more concerning about the convenience and low air pollution of the fuel, most barbecue grills adopt gas as the fuel, and it is advantageous that the firepower can be easily controlled, and simultaneously, the smoke which might cause air pollution also can be avoided. Furthermore, a rolling shaft, which may be used to string up the food, such as porkling, chicken or fish, is crossed on the grill shelf, and one end of the rolling shaft is connected to a motor 1, wherein motor 1 can drive the rolling shaft to roll on the shelf through a reduction gear, so that the food can have an automatic rolling for constantly changing the position, thereby being grilled averagely until the outside and the inside are both ready. Since some kinds of food, such as, porkling or chicken, have to be grilled by a small or medium fire for preventing from scorched outer skin with raw inside, it always needs a long time for grilling, so that the user usually will utilize the long grilling time to engage in some sports or games. However, a good operation of the motor 1 is depending on sufficient charging power, and thus, if the power supply is interrupted during grilling and the user is absent or ignores this situation, the food will be scorched. But, if the power supply to the motor 1 is interrupted as in the outdoors, charging will become a problem, so that, obviously, it is not only inconvenient but also time-consuming, and then, the user is forced to roll the shaft by hand.

Consequently, the applicant keeps on carving unflaggingly through wholehearted experience and research to develop a barbecue grill transmission device which can solve the inefficient problem in the prior art.

### SUMMARY OF THE INVENTION

The object of the present invention is to provide a barbecue grill transmission device including a grill platen having a grill shelf mounted at the top thereof, and a pair of grooves at two sides of the grill shelf for pivotally a rolling shaft, which is used to string up food to be roasted, wherein one end of the rolling shaft is connected to a spiral spring, and the spring is connected to a detector, which receives a signal related to the releasing of the spring and then transmits a signal to a beeper for generating a sound to warn the complete releasing of the spring, thereby automatically rolling the food strung on the rolling shaft to roll on the grill shelf without being driven by the power-driven motor, so as to achieve power saving.

Another object of the present invention is to provide a barbecue grill transmission device whose detector can produce a sound effect for warning the user when the spring is almost completely released, so as to avoid the rolling shaft from stopping rolling and also prevent from scorch.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a three-dimensional schematic view showing a conventional barbecue grill;

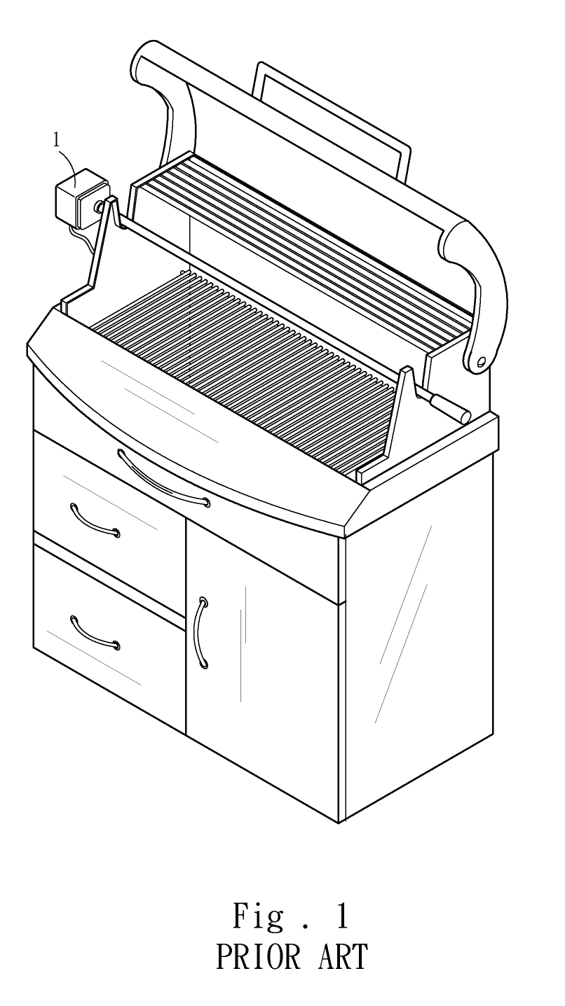

FIG. 2 is a three-dimensional view showing a preferred embodiment of the present invention; and

FIG. 3 is block diagram showing a preferred embodiment of the present invention.

### DESCRIPTION OF THE PREFERRED EMBODIMENT

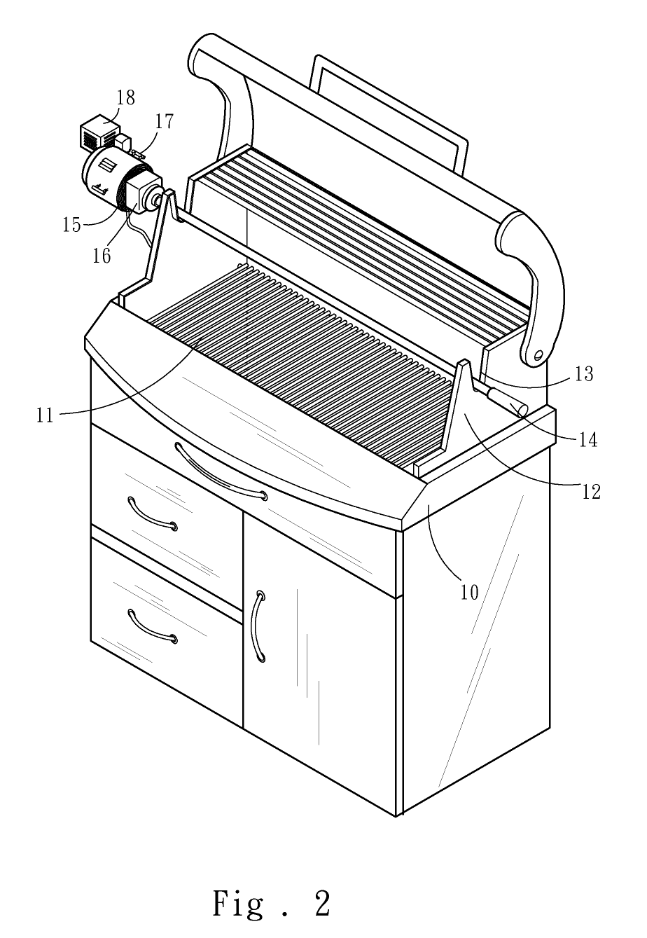

Please refer to FIG. 2. The present invention is related to a barbecue grill with transmission device including:

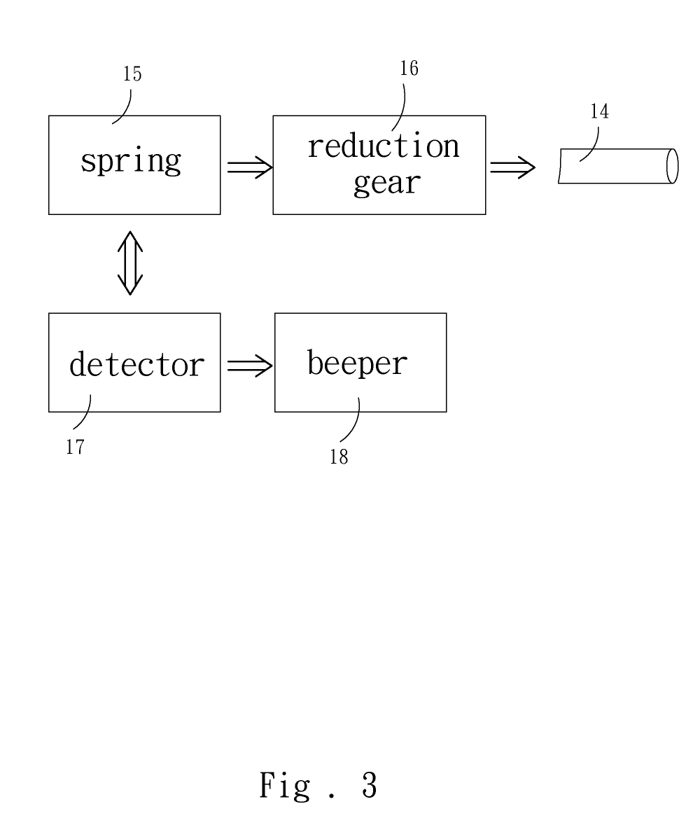

a rectangular grill platen 10, wherein the grill platen 10 has a grill shelf 11 mounted at the top thereof with a pair of flake-typed racks 12 mounted at two sides thereof, and the racks 12 have a pair of U-shaped grooves 13 for pivotally and transversely mounting a rolling shaft 14, which can string up the food to be roasted. The rolling shaft 14 is connected to a spiral spring 15 through one end thereof and the rolling speed of the rolling shaft 14 can be reduced through a reduction gear 16, as shown in FIG. 3. Moreover, the spring 15 is also connected to a detector 17, which can receive a signal from the spring 15 so as to transmit a signal to a beeper 18, and then, according to the flexibility of the spring 15, the beeper 18 can produce a sound to warn that the spring 15 has been completely released.

When operation, the rolling shaft 14 on the grill shelf 11 can string up the food to be roasted, such as chicken, duck, goose, porkling, fish or vegetables, in advance. Then, the spiral spring 15 is tightened and the flexible recovering force of the spiral spring 15 will be released slowly, so that the rolling shaft 14 is forced to automatically roll on the grill shelf 11, thereby rolling the food. When the spring 15 releases, the detector 17 can detect the tightness thereof, so that when the spring 15 is totally released, the beeper 18 can generate a sound for notifying the user the stop of the rolling shaft 14, thereby the user may check the grill for deciding if the operation should be continued.

Since, in the present invention, the motive power of the rolling shaft 14 is provided by the recovering force released by the tightened spring 15, even the barbecue grill is carried to the outdoors, the interruption of motor operation due to electricity exhausting will no longer happen, and the scorching problem also can be avoided.

Besides, the present invention utilizes the recovering force of the spring 15 to drive the rolling shaft 14 and also the food to roll on the shelf, so that it is advantageous of power saving, and thus, the barbecue grill of the present invention can be carried to the outdoor at any time without considering the power problem.

In the aforesaid, the present invention not only can conform to practical usages but also can achieve excepted purposes and effects, so that it is really a valuable application.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A barbecue grill transmission device, comprising:
a grill platen having a grill shelf mounted at the top thereof, and a pair of grooves at two sides of the grill shelf for pivotally a rolling shaft, which is used to string up food to be roasted, wherein one end of the rolling shaft is connected to a spiral spring so as to force the rolling shaft to automatically roll on the grill shelf.

2. The barbecue grill transmission device as claimed in claim 1, wherein a rolling speed of the spring is reduced by a reduction gear.

3. The barbecue grill transmission device as claimed in claim 1, wherein the spring is connected to a detector, and the detector receives a signal related to the releasing of the spring and then transmits a signal to a beeper for generating sound, so as to warn the complete releasing of the spring.
